(19) United States
(12) Patent Application Publication
(10) Pub. No.: US 2009/0168434 A1
(43) Pub. Date: Jul. 2, 2009

(54) Illuminating Device

(76) Inventor: Chi-Wen Chen, Taipei City (TW)

Correspondence Address: BINGHAM MCCUTCHEN LLP, Three Embarcadero Center, San Francisco, CA, 94111-4067, US

(21) Appl. No.: 11/966,603

(22) Filed: Dec. 28, 2007

(51) Int. Cl. F21V 7/00

(52) U.S. Cl. 362/308

(57) ABSTRACT

An illuminating device includes a light-emitting unit and a light-reflecting unit. The light-emitting unit includes a housing and a light source disposed in the housing. The housing has one end formed with a light exit opening that is disposed along an optical path of light emitted by the light source. The light-reflecting unit is mounted detachably to the housing at the light exit opening, and includes a light-reflecting component for reflecting the light emitted by the light source. The housing is configured with a side light window disposed along a path of the light reflected by the light-reflecting component. The light emitted by the light source exits the housing via the light exit opening when the light-reflecting unit is detached from the housing, and exits the housing via the side light window when the light-reflecting unit is attached to the housing.

### BACKGROUND OF THE INVENTION

1. Field of the Invention

The invention relates to an illuminating device, more particularly to an illuminating device that is capable of both forward and sideward light emission.

2. Description of the Related Art

Illuminating devices are commonly used in a work environment when ambient light is insufficient.

It is desirable to provide an illuminating device that can be configured for forward light emission or sideward light emission according to the requirements of the user.

### SUMMARY OF THE INVENTION

Therefore, the object of the present invention is to provide an illuminating device that can be configured by the user for forward light emission or sideward light emission.

Accordingly, an illuminating device of this invention comprises a light-emitting unit and a light-reflecting unit. The light-emitting unit includes a housing and a light source disposed in the housing. The housing has one end formed with a light exit opening that is disposed along an optical path of light emitted by the light source. The light-reflecting unit is mounted detachably to the housing at the light exit opening, and includes a light-reflecting component for reflecting the light emitted by the light source. The housing is configured with a side light window disposed along a path of the light reflected by the light-reflecting component. The light emitted by the light source exits the housing via the light exit opening when the light-reflecting unit is detached from the housing, and exits the housing via the side light window when the light-reflecting unit is attached to the housing.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an illuminating device according to the present invention;

FIG. 2 is an assembled perspective view of the preferred embodiment when configured for sideward light emission;

FIG. 3 is a fragmentary sectional view to illustrate coupling between a light-emitting unit and a light-reflecting unit of the preferred embodiment;

FIGS. 4a to 4c are fragmentary perspective views to illustrate how the light-reflecting unit is attached to the light-emitting unit in the preferred embodiment; and

FIG. 5 is an assembled perspective view of the preferred embodiment when configured for forward light emission.

### DETAILED DESCRIPTION OF THE PREFERRED EMBODIMENT

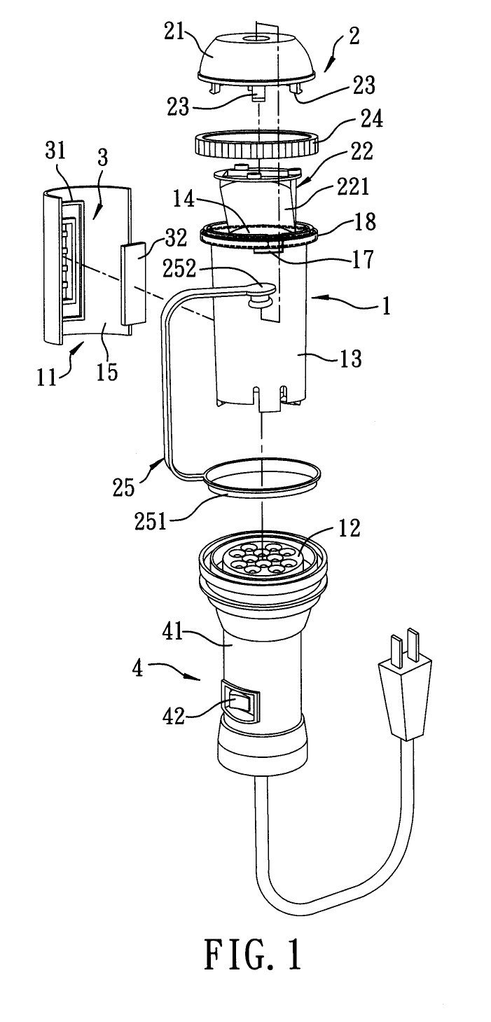

FIGS. 1 to 3 illustrate the preferred embodiment of an illuminating device according to the present invention. In this embodiment, the illuminating device utilizes a commercial power source as a source of electricity. In practice, the illuminating device may utilize batteries (not shown) as the source of electricity.

The illuminating device includes a light-emitting unit 1, alight-reflecting unit 2, a magnetic positioning unit 3, and a handle unit 4.

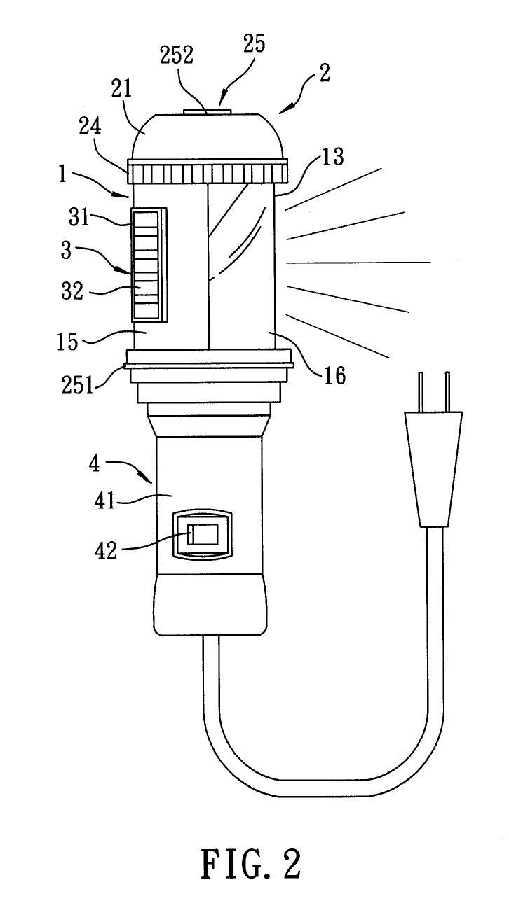

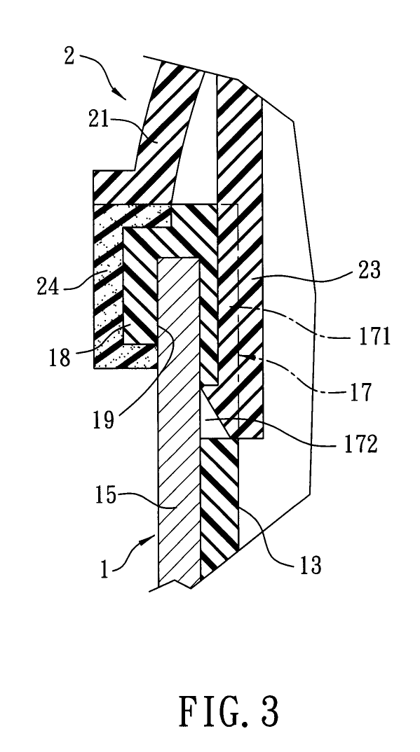

The light-emitting unit 1 includes a housing 11 that has opposite housing ends respectively connected to the light-reflecting unit 2 and the handle unit 4, and a light source 12 that is disposed in the housing 11 adjacent to the housing end connected to the handle unit 4. In this embodiment, the light source 12 is formed from a plurality of light-emitting diodes and is suitably controlled such that light emitted by the light source 12 travels along a straight optical path. In this embodiment, the housing 11 includes a transparent cylindrical barrel portion 13 and an opaque curved shield portion 15 that is disposed on an outer side of the barrel portion 13, that is rotatable about an axis of the barrel portion 13, and that cooperates with the barrel portion 13 to configure the housing 11 with a side light window 16 (see FIG. 2). One end of the barrel portion 13 distal from the handle unit 4 is formed with an annular flange 18 that has a L-shaped cross section. The annular flange 18 cooperates with the outer side of the barrel portion 13 to confine an annular groove 19 (see FIG. 3). The shield portion 15 has one end that is slidably retained in the annular groove 19 (see FIG. 3). Therefore, through rotation of the shield portion 15 relative to the barrel portion 13, the actual orientation of the side light window 16 on the housing 11 can be varied as desired. The housing end opposite to the handle unit 4 is formed with a light exit opening 14 that is disposed along the straight optical path of the light emitted by the light source 12. The light exit opening 14 has an area smaller than that of the side light window 16. The barrel portion 13 is further formed with a plurality of retaining grooves 17 (only one is shown in FIG. 1) angularly spaced apart from one another. As best shown in FIG. 3, each of the retaining grooves 17 has an axially extending groove segment 171 that extends to the housing end opposite to the handle unit 4, and a circumferentially extending groove segment 172 that extends from one end of the axially extending groove segment 171 opposite to the light exit opening 14.

The light-reflecting unit 2 includes a cap member 21 mounted detachably to the barrel portion 13 of the housing 11 at a periphery of the light exit opening 14, a light-reflecting component 22 connected to the cap member 21 and extending into the barrel portion 13, a plurality of hook members 23 provided on the cap member 21 for engaging removably and respectively the retaining grooves 17, a resilient ring 24 having a U-shaped cross section and sleeved removably on the annular flange 18, and a strap member 25. The resilient ring 24 is disposed to abut against a periphery of the cap member 21 so as to seal a clearance formed between the cap member 21 and the barrel portion 13 when the cap member 21 is attached to the barrel portion 13. The strap member 25 has one end 251 in the form of a ring that is connected to the housing end opposite to the light-reflecting unit 2, and an opposite end 252 connected to the cap member 21. Accordingly, the cap member 21 can be prevented from being misplaced when detached from the barrel portion 13. The light-reflecting component 22 is in the form of an inverted triangular block, and has an inclined curved reflecting surface 221 that faces toward the side light window 16 of the housing 11 and that forms an acute angle with the side light window 16. The light-reflecting component 22 serves to reflect the light emitted by the light source 12, and the side light window 16 is disposed along a path of the light reflected by the light-reflecting unit component 22.

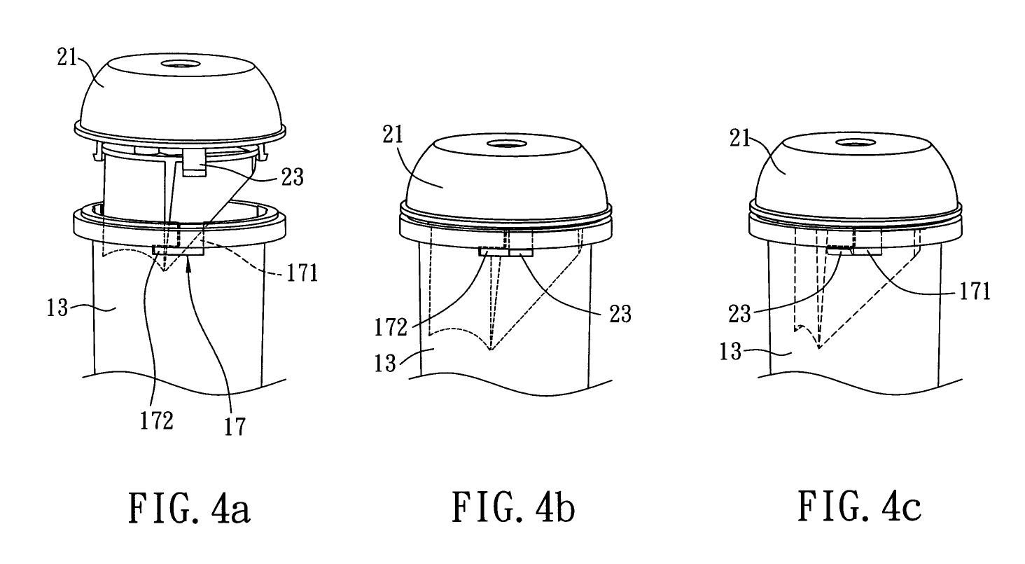

Referring to FIGS. 4a to 4c, when attaching the light-reflecting unit 2 to the light-emitting unit 1, each of the hook members 23 of the light-reflecting unit 2 is first extended into the respective one of the retaining grooves 17 in the barrel portion 13 of the housing 11 via the axially extending groove segment 171, and the cap member 21 is then turned slightly relative to the barrel portion 13 so that each of the hook members 23 is retained in the respective one of the retaining grooves 17 by the circumferentially extending groove segment 172.

Referring back to FIGS. 1 and 2, the magnetic positioning unit 3 includes a positioning component 31 in the form of a grid and provided on the shield portion 15 of the housing 11, and a magnet 32 received in the positioning component 31 for providing a positioning effect by magnetic attraction. Through the magnetic positioning unit 3, the illuminating device can be positioned on a metal surface, such as a metal wall.

The handle unit 4 includes a handle body 41 mounted on the housing end opposite to the light-reflecting unit 2, and a switch 42 mounted on the handle body 41 and coupled to the light source 12 for controlling light emitting activity of the light source 12.

As shown in FIG. 2, to configure the illuminating device for sideward light emission, the light-reflecting unit 2 is attached to the housing 11 at the light exit opening 14 via the hook members 23 and the retaining grooves 17, such that the light emitted by the light source 12 is reflected by the light-reflecting component 22 to exit the housing 11 via the side light window 16. The configuration as such is suitable for short-distance soft illumination requirements. Moreover, through rotation of the shield portion 15 relative to the barrel portion 13, orientation of the side light window 16 as well as that of the light that exits the side light window 16 can be varied as desired.

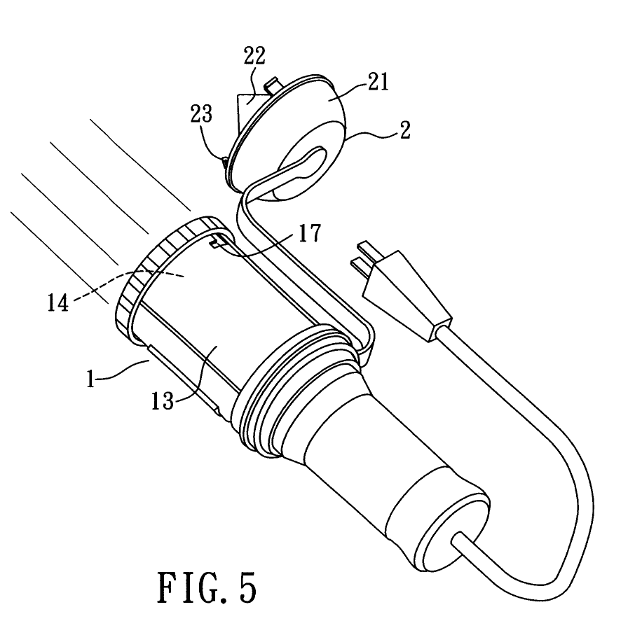

As shown in FIG. 5, to configure the illuminating device for forward light emission, the light-reflecting unit 2 is simply detached from the light-emitting unit 1, such that the light emitted by the light source 12 exits the housing 11 via the light exit opening 14. The configuration as such is suitable for long-distance bright illumination requirements.

Furthermore, the handle body 41 of the handle unit 4 may be gripped to facilitate moving the illuminating device around. Moreover, the magnetic positioning unit 3 can be used to position the illuminating device on a metal surface when fixed-point illumination is desired.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An illuminating device comprising:
a light-emitting unit including a housing and a light source disposed in said housing, said housing having one end formed with a light exit opening that is disposed along an optical path of light emitted by said light source; and
a light-reflecting unit mounted detachably to said housing at said light exit opening, said light-reflecting unit including a light-reflecting component for reflecting the light emitted by said light source;
said housing being configured with a side light window disposed along a path of the light reflected by said light-reflecting component;
wherein the light emitted by said light source exits said housing via said light exit opening when said light-reflecting unit is detached from said housing, and exits said housing via said side light window when said light-reflecting unit is attached to said housing.

2. The illuminating device as claimed in claim 1, wherein said light-reflecting unit further includes a cap member mounted detachably to a periphery of said light exit opening, said light-reflecting component being connected to said cap member and having an inclined curved reflecting surface that faces toward said side light window of said housing.

3. The illuminating device as claimed in claim 2, wherein said light exit opening has an area smaller than that of said side light window.

4. The illuminating device as claimed in claim 1, wherein said housing includes a transparent cylindrical barrel portion that defines said light exit opening, and an opaque curved shield portion that is disposed on an outer side of said barrel portion and that cooperates with said barrel portion to configure said housing with said side light window.

5. The illuminating device as claimed in claim 4, wherein said barrel portion is formed with an annular flange that cooperates with said outer side of said barrel portion to confine an annular groove, said shield portion having one end that is slidably retained in said annular groove.

6. The illuminating device as claimed in claim 4, wherein said barrel portion is formed with a plurality of retaining grooves, and said light-reflecting unit further includes a plurality of hook members to engage removably and respectively said retaining grooves.

7. The illuminating device as claimed in claim 6, wherein each of said retaining grooves has an axially extending groove segment that extends to said one end of said housing, and a circumferentially extending groove segment that extends from one end of said axially extending groove segment opposite to said light exit opening,
each of said hook members being extendible into the respective one of said retaining grooves via said axially extending groove segment, and being retained in the respective one of said retaining grooves by said circumferentially extending groove segment.

8. The illuminating device as claimed in claim 5, wherein said light-reflecting unit further includes a resilient ring sleeved removably on said annular flange.

9. The illuminating device as claimed in claim 2, wherein said light-reflecting unit further includes a strap member having one end connected to said cap member and an opposite end connected to said housing.

10. The illuminating device as claimed in claim 1, further comprising a magnetic positioning unit that includes a positioning component provided on said housing, and a magnet received in said positioning component.

11. The illuminating device as claimed in claim 1, further comprising a handle unit mounted on said housing opposite to said light exit opening, said handle unit including a handle body mounted on said housing, and a switch mounted on said handle body and coupled to said light source for controlling light emitting activity of said light source.
